(19) United States
(12) Patent Application Publication
(10) Pub. No.: US 2013/0270955 A1
(43) Pub. Date: Oct. 17, 2013

(54) ELECTROMAGNETIC MACHINE

(71) Applicant: Paul Evan Lillington, Lugarno (AU)

(72) Inventor: Paul Evan Lillington, Lugarno (AU)

(73) Assignee: GLOBAL MOTORS INVENT PTY LTD, Padstow (AU)

(21) Appl. No.: 13/878,425

(22) PCT Filed: Oct. 5, 2011
(86) PCT No.: PCT/AU2011/001279

§ 371 Date: Jul. 2, 2013

(30) Foreign Application Priority Data
Oct. 8, 2010 (AU) 2010904498

(51) Int. Cl. H02K 1/27; H02K 15/03

(52) U.S. Cl. CPC H02K 1/2773; H02K 15/03
USPC 310/156.11; 29/598

(57) ABSTRACT

There is provided an electromagnetic machine (100) having an inner and outer stator (110), and a rotor and a plurality of magnets (140) embedded in the rotor (130). The magnets (140) are configured such that the orientation of the magnetic polar axis of each magnet (140) is tangential to the direction of rotation of the rotor (130) and the magnetic polar axis of each magnet is opposite to the direction of the magnetic polar axes of the adjacent magnets to provide radial magnetic fields.

### FIELD

This invention relates generally to electromagnetic machines.

### BACKGROUND

Existing electromagnetic machines, such as permanent magnet electromagnetic motors or generators, have magnets bonded to the surface of a rotor in a radial orientation to create radial magnetic fields. However, these arrangements suffer from the disadvantage of being mechanically weak, difficult to manufacture and exposing magnets to demagnetization at high currents loads. There are also designs which use buried magnets in their rotor. These come in two types.

The first type is where the magnet has a magnetic pole piece between it and the air gap but is still has the same magnetic orientation as the surface magnets. These designs, is although mechanically strong, suffer from large flux drag problems which give large harmonic distortion under load, and therefore poor waveforms. The air gap flux in these designs is also lower for surface-mounted magnet designs.

The second type of buried magnet designs are termed flux concentrator designs. In these designs, the magnets are placed into the rotor with their flux orientation tangential to the air gap, and the flux from the magnet is concentrated into a iron pole piece between them. These rotor designs suffer not only from the flux drag problem and high distortion under load, but also from the flux being pushed out of the air gap down into the rotor under high loads. They do, however, have high air gap flux under no load.

A need exists to overcome or at least to ameliorate some of the disadvantages of the existing arrangements.

### SUMMARY

According to one aspect, there is provided an electromagnetic machine comprising an inner stator, an outer stator, a rotor located between the inner and outer stator, and a plurality of permanent magnets embedded in the rotor. The magnets are configured such that the orientation of the magnetic polar axis of each magnet is tangential to the direction of rotation of the rotor, and the magnetic polar axis of each magnet is opposite to the direction of the magnetic polar axes of the adjacent magnets to provide radial magnetic fields.

According to another aspect, there is provided a method comprising forming an inner stator lamination, an outer stator lamination and a rotor lamination from a single sheet of material and assembling a rotor from one or more of the laminations. The rotor is configured to accommodate magnets such that the orientation of the magnetic polar axis of each magnet is tangential to the direction of rotation of the rotor and the magnetic polar axis of each magnet is opposite to the direction of the magnetic polar axes of the adjacent magnets to provide radial magnetic fields.

Other aspects are disclosed.

### BRIEF DESCRIPTION OF THE DRAWINGS

By way of example, embodiments of the invention will now be described with reference to the accompanying drawings, in which:

FIG. 1 shows an electromagnetic machine in accordance with an embodiment;

FIG. 2 shows side sectional view of the electromagnetic machine of FIG. 1;

FIG. 3 shows a front sectional view of the electromagnetic machine of FIG. 1;

FIG. 4 shows the magnetic field lines of the electromagnetic machine of FIG. 1;

FIG. 5A shows a partial manufacture process of the electromagnetic machine of FIG. 1;

FIG. 5b shows enlarged detail of a portion of FIG. 5A;

FIG. 6 shows an exploded view of rotor parts of the electromagnetic machine of FIG. 1; and

FIG. 7 shows a winding scheme.

### DETAILED DESCRIPTION

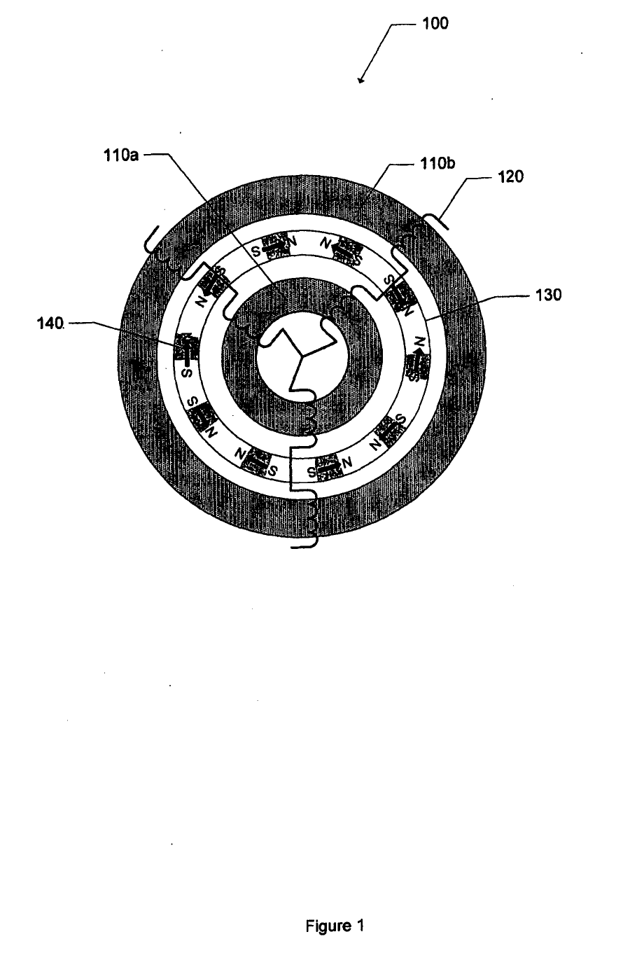

Referring to FIG. 1, there is shown an electromagnetic machine 100. The electromagnetic machine 100 has three-phase windings 120, an inner stator 110a, and outer stator 110b, and a rotor 130 there between. The rotor 130 has a plurality of embedded magnets 140. The magnets 140 typically are permanent magnets. The direction of the magnetic polar axis of each magnet 140 is tangential to the direction of rotation of the rotor 130. The direction of the magnetic polar axis of each magnet 140 is opposite to the direction of the magnetic polar axes of the immediately adjacent magnets 140 to provide radial magnetic fields. The electromagnetic machine 100 may be used in either a motor or generator configuration. Typically, two stators are provided, however, as can be appreciated by a person skilled in the art, any number of stators may be provided. Also, three phase windings are provided, however, as can be appreciated by a person skilled in the art, single phase windings may be provided.

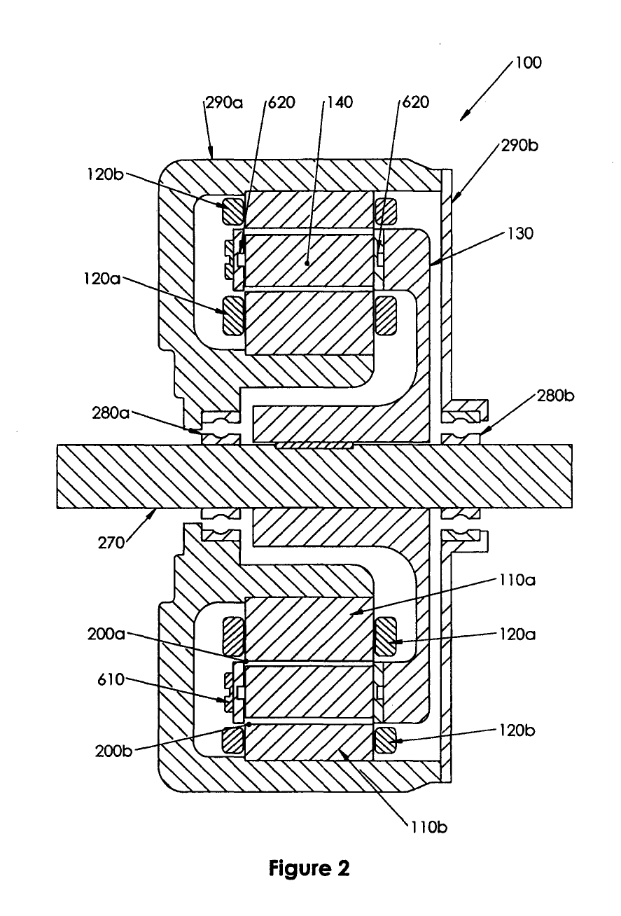

FIG. 2 shows a side sectional view of the electromagnetic machine 100. The magnets 140 are embedded in the rotor 130. The rotor 130 in one form is constructed from steel laminates. The magnets can be rectangular in shape for ease of manufacture and ease of insertion into the steel laminates. The number of embedded magnets required is half the number of surface mounted magnets that would be required for a machine having the same number of poles.

The magnets 140 contained within the steel laminates can be divided into sections to reduce eddy current flow in the rotor and magnets to reduce heating effects. The embedded magnets 140 do not limit the rotational speed of the rotor whereas surface mounted magnets do, since surface mounted magnets are likely to become detached due to the large forces experienced at high rotational speeds. The embedded magnets 140 also are thicker than surface mounted magnets 140 and are therefore more robust.

The rotor 130 is able to withstand higher shock and higher speeds compared to a rotor having surface mounted magnets, as the embedded magnets 140 are held in place by the steel laminates. Further, the embedded magnets 140 reduce the necessary air gap compared with raised surface-mounted magnets. The embedded magnets 140 are protected from demagnetization at high current loads by reducing the interaction of the magnetic flux from the coils with the magnets 140 thereby providing lower synchronous reluctance, which gives better voltage regulation when the machine is operated as a generator. The rotor 130 rotates between two stators 110 about a shaft 270, with air gaps 200 between each. The stators 110 preferably are made of a high permeability, low loss laminated material. The shaft 270 rotates on bearings 280 within an outer housing 290. The magnetic fields of magnets 140 embedded in the rotor 130 cross the air gaps 2000 to interact with windings 120 in the stators 110 to create torque in the case of a motor, or voltage in the case of a generator. The rotor 130, stators 110 and windings 120 are arranged to provide equal torque or voltage on both the outer stator 110b and inner stator 110a, as described below.

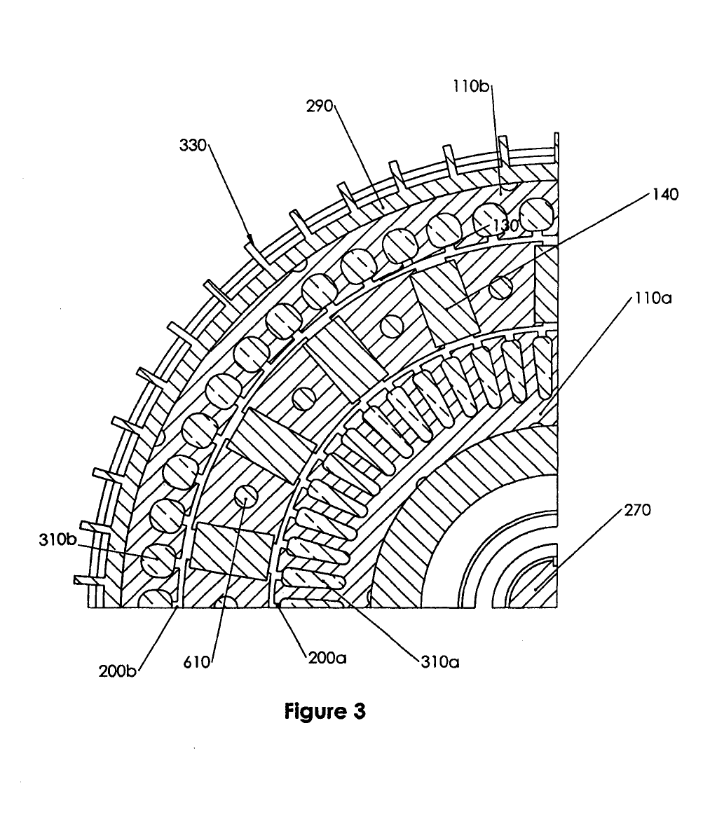

Referring also to FIG. 3A, there is shown a front section view of the rotor 130 positioned between the stators 110. Also shown are the magnets 140, being located in the rotor 130. The position and orientation of the magnets 140 provides magnetic flux that intersects both the inner and outer surface of the rotor 130, as described below. The stators 110 are provided with slots 310 to accommodate the windings 120. Heat generated by the windings 120 flows to the casing 290 and is dissipated by fins 330. Any effect of cogging torque can be alleviated by skewing the stator one slot pitch.

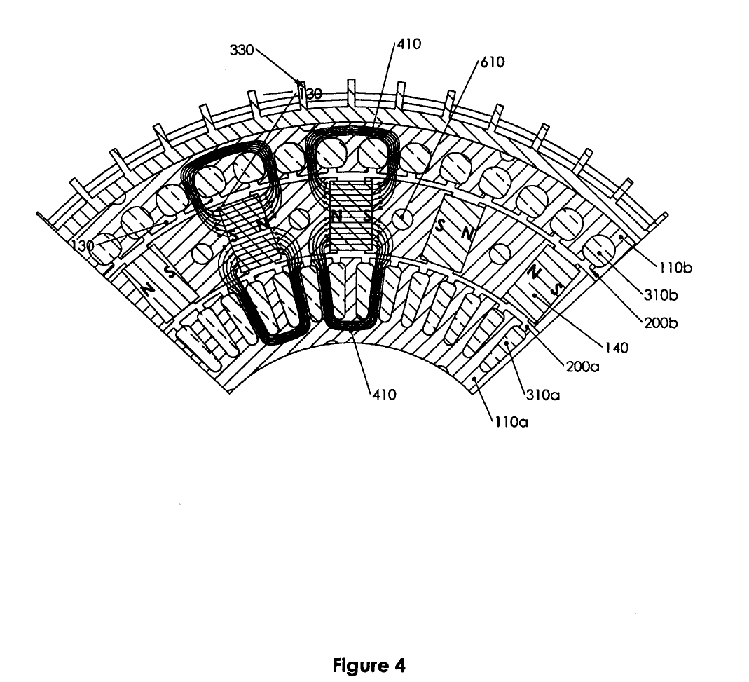

Turning now to FIG. 4, there is shown a front section view of the rotor 130 positioned between the stators 110, wherein the magnetic polar axis (N-S) of each magnet 140 is tangential to the direction of rotation of the rotor 130. Also shown are the radial magnetic field lines 410 of the magnets 140 due to the orientation of the magnetic polar axis of each magnet 140 being opposite to the direction of the magnetic polar axes of the magnets.

In conventional twin stator arrangements, the magnetic flux density of the inner air gap typically is greater than the magnetic flux density in the outer air gap. Also in conventional stator arrangements, the relative speed of the stator to the rotor is greater at the outer stator when compared to the inner stator. The winding slots 310 of the embodiment are arranged to compensate for the difference in magnetic flux density and velocity of the inner stator 110a and the outer stator 110b by providing the inner stator 110a with deeper and narrower winding slots 310a compared to the winding slots 310b of the outer stator 110b. The tooth width of the inner winding slots 310a matches the tooth width of the outer winding slots 310b. The coil slots in the inner stator 110a and the outer stator 110b are arranged so that the wire cross-sectional area for both stators is the same, resulting in the same volume of copper wire in the inner stator as in the outer stator.

The outer stator winding slots 310b can be skewed in a different direction to the skew of the inner stator winding slots 310a to reduce the cogging torque due to the interaction between the permanent magnets of the rotor and the winding slots 310. For close-coupled generator arrangements, the bearing 280b and outer housing 290b may be eliminated. In this instance, the generator would typically have a short length to reduce the overhanging load on the driving motor bearings, and therefore being compact and lighter.

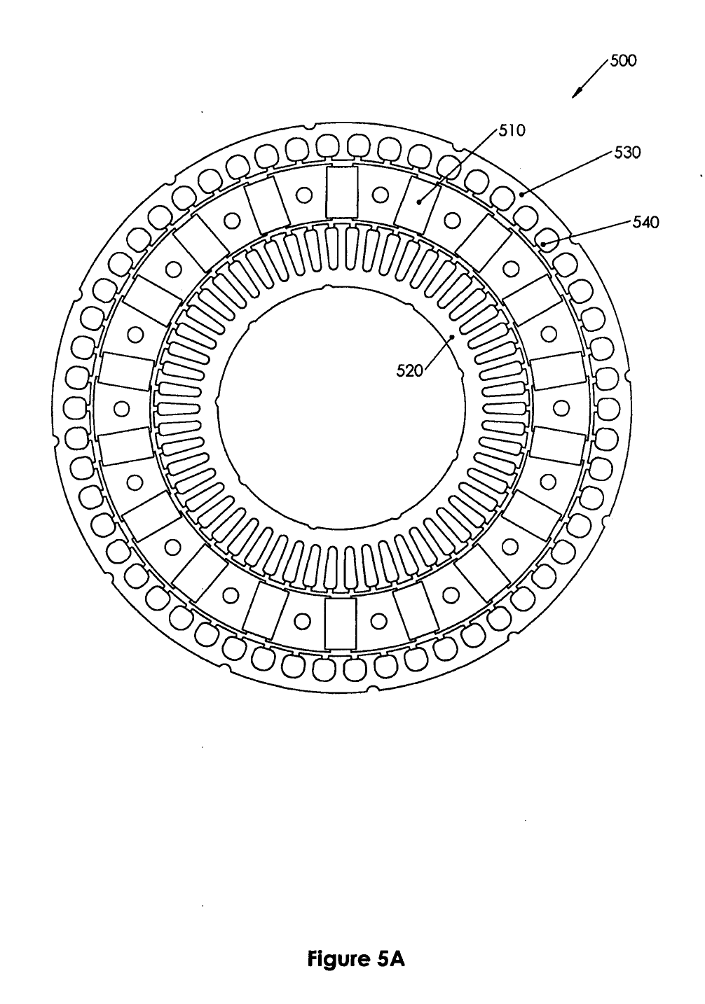

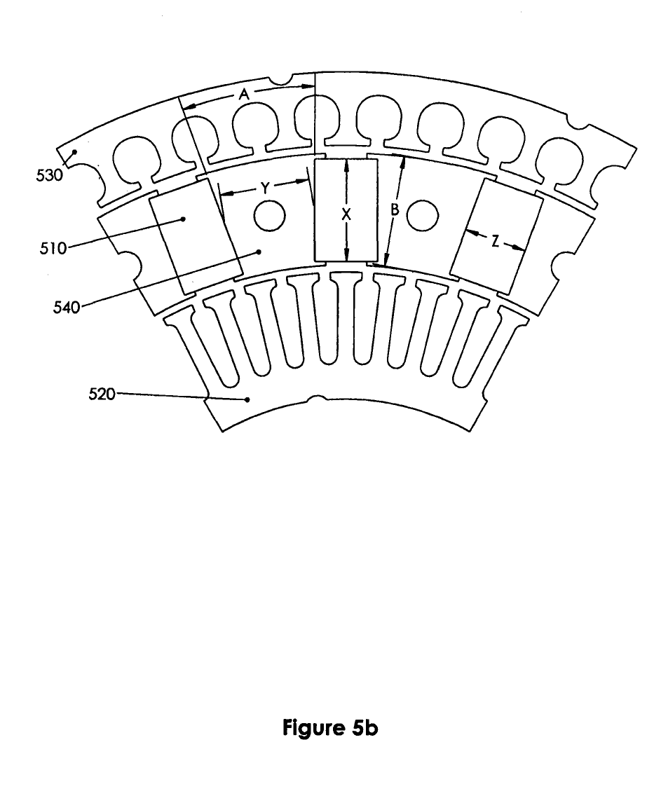

Also provided is a method of manufacturing an electromagnetic machine where residue material stamped from within the outer laminates is used to fabricate the inner laminates. FIG. 5A shows the multi stage die templates 500 for punching for the inner stator laminations 520, the outer stator laminations 530 and the rotor laminations 540 from a single sheet of material. The inner stator laminations 520, the outer stator laminations 530 and rotor laminations 540 are produced at the same time in a multi-stage die from the same piece of material. This method of manufacture reduces the amount of material lost in the manufacturing process. The slots 510 receive magnets, in the assembled form.

FIG. 5B shows enlarged detail of the laminations 520, 530, 540 of FIG. 5A. To obtain the most efficient use out of a given volume of magnet material in a motor or generator the combination of two magnets (N and S poles) should approximate a cube, which is the ideal shape for a magnet to give maximum power. Maximal power also requires keeping the air gap flux density as high as possible, as well as keeping the magnet volume high to give power under load. However, if the air gap flux is high, but the magnets do not have sufficient length to overcome demagnetization loads, the voltage will drop under load and the power generated will be limited.

Another consideration is to design a machine with a high saliency. Saliency has the effect of keeping voltage drop low when a machine is operated as a generator, and allows field weakening when a machine is operated as a motor. In conventional surface-mounted magnet motors and generators the saliency is around 1, a saliency of over 3 gives better performance. In the arrangement shown in FIG. 5B, both high saliency and high air gap flux are achieved. In this arrangement, the dimensions of: magnet length “X”, mid-line separation of adjacent magnets “Y”, magnet width “Z”, outer stator arc length between adjacent magnets “A” and rotor depth “B” are varied to satisfy the requirements of high air gap flux and high saliency, while maintaining the magnet volumes as low as possible for the best power to weight ratio. The void in the magnetic flux path created by the bolt 610 also increases the saliency also. In one example, a dual stator optimum ratio is obtained when “Z”≈“Y/2”, “X”≈“Z*2” and “B” “A. These ratios are approximate in the range ±15%.

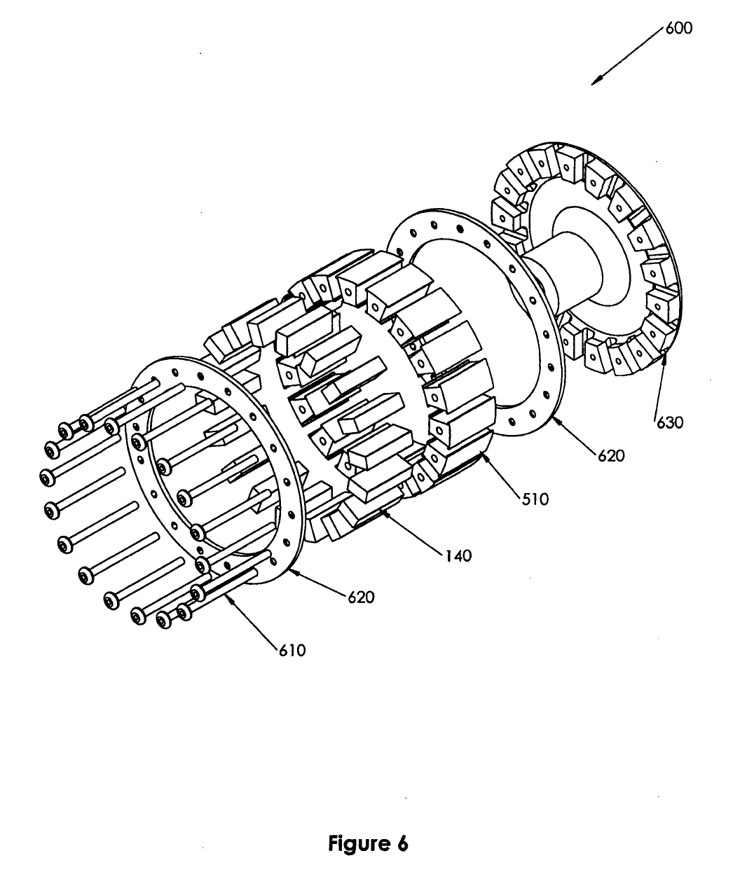

FIG. 6 shows an exploded view 600 of rotor parts. The rotor 130 is assembled by combining the punched rotor laminations 540 with one or more end ring stampings 620. The magnets 140 are inserted into the magnet slots 510 of the rotor assembly and bolted, riveted or clamped together to form a rigid mechanically strong rotor 130, attached to rotor support 630. The bolts or rivets 610 used can be made of a non-magnetic material, such as “3110 stainless steel”, as the area they pass through is a dead spot for the magnetic flux. This arrangement reduces the stray flux loss into the end castings, and allows for a shorter overall length and reduced losses. Assembly of the rotor in this manner allows for a simple and a strong rotor assembly that can be readily assembled by automated means and readily disassembled for servicing.

It can also be seen that the short length of the electromagnetic machine 100 allows for the electromagnetic machine 100 to be stacked together with other electromagnetic machines 100 to a common shaft for increased power.

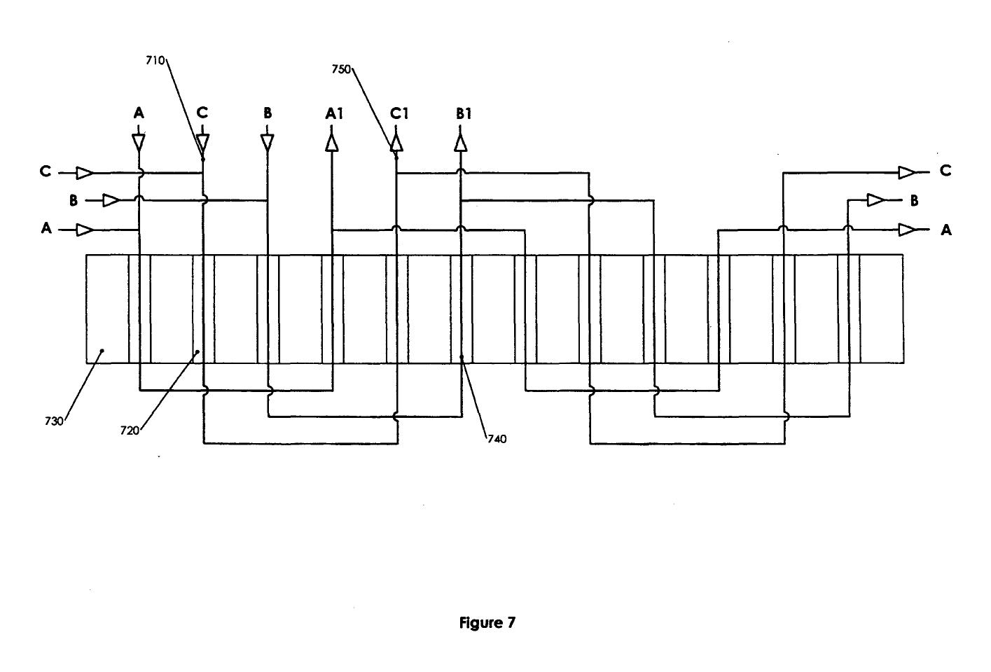

In order to achieve the maximum energy density from a generator or motor winding, it is necessary to have the maximum amount of copper in the slots (“slot fill factor”), and to minimize the length of wire in the end windings and coil interconnections. FIG. 7 shows a suitable winding scheme for this purpose, termed “continuous wave winding”. This winding process is particularly effective when the generator or motor has high poles numbers and low voltage. The scheme eliminates all inter-coil connections within the stators end windings.

Take, for example, phase winding “C”. This winding starts at point 710 and is laid in the first slot 720, passes around the stator 730, then is laid in slot 740, and so on around the whole stator, returning to the start slot 720. The winding continues around the stator 720 again, until the required number of turns is laid in the slots, and then exits at point 750. The number of circuits completed around the stator is equal to the number of required turns in the slot. The same occurs for phases A and B. This scheme gives a high slot fill factor as well as eliminating the inter-coil connections. This winding scheme is suited for large frame motors and generators, and motors and generators designed for low voltage. It is also an appropriate winding arrangement for motors and generators with high pole numbers, where there typically would otherwise be many inter-coil connections.

The foregoing describes only some embodiments of the present invention, and modifications and/or changes can be made thereto without departing from the scope and spirit of the invention, the embodiments being illustrative and not restrictive.

1. An electromagnetic machine comprising:
an inner stator;
an outer stator;
a rotor located between the inner and outer stator; and
a plurality of permanent magnets embedded in the rotor, the magnets being configured such that the orientation of the magnetic polar axis of each magnet is tangential to the direction of rotation of the rotor, and the magnetic polar axis of each magnet is opposite to the direction of the magnetic polar axes of the adjacent magnets to provide radial magnetic fields.

2. The electromagnetic machine of claim 1, wherein, for the rotor at least one of the conditions is satisfied: the magnet width is approximately half that of the mid-line separation of adjacent magnets, the magnet length is approximately twice that of the magnet width, the rotor depth is approximately the same as the outer stator arc length between adjacent magnets.

3. The electromagnetic machine of claim 1, wherein at least one of the conditions is satisfied: the magnet width is approximately half that of the mid-line separation of adjacent magnets, the magnet length is approximately half that of the mid-line separation of adjacent magnets, the rotor depth is approximately half that of the outer stator arc length between adjacent magnets.

4. The electromagnetic machine of any preceding claim, wherein the stators have winding slots arranged to compensate for the difference in magnetic flux density of the magnets interacting with each respective stator and the difference in relative speed of each respective stator and the rotor.

5. The electromagnetic machine of claim 4, wherein the winding slots of the inner stator are deeper or narrower than the winding slots of the outer stator.

6. The electromagnetic machine of claim 4 or claim 5, wherein winding slots of the first stator and the second stator are skewed in different directions.

7. The electromagnetic machine of any one of the preceding claims, wherein the magnets are rectangular.

8. The electromagnetic machine of any one of the preceding claims, wherein the magnets are divided into sections.

9. The electromagnetic machine of any one of the preceding claims, wherein the rotor comprises steel laminates.

10. The electromagnetic machine of any one of the preceding claims, wherein the stators are high permeability low loss laminated material.

11. The electromagnetic machine of any one of the preceding claims being a motor.

12. The electromagnetic machine of any one of claims 1 to 11 being a generator.

13. The electromagnetic machine of any one of the preceding claims, further comprising a single phase winding on the stators.

14. The electromagnetic machine of any one of the preceding claims, further comprising three phase windings on the stators.

15. The electromagnetic machine of any one of the preceding claims wherein the rotor includes at least one void in the rotor material located between each adjacent magnet.

16. A method comprising:
forming an inner stator lamination, an outer stator lamination and a rotor lamination from a single sheet of material; and
assembling a rotor from one or more of the laminations, the rotor being configured to accommodate magnets such that the orientation of the magnetic polar axis of each magnet is tangential to the direction of rotation of the rotor, and the magnetic polar axis of each magnet is opposite to the direction of the magnetic polar axes of the adjacent magnets to provide radial magnetic fields.
